(19) United States
(12) Patent Application Publication
(10) Pub. No.: US 2005/0251745 A1
(43) Pub. Date: Nov. 10, 2005

(54) Input switching method and electronic device therefor

(76) Inventors: Sen-Hao Lan, Taoyuan City (TW); Horng-Yi Chang, Taipei City (TW)

Correspondence Address: RABIN & Berdo, PC, 1101 14TH STREET, NW, SUITE 500, WASHINGTON, DC, 20005, US

(21) Appl. No.: 11/092,695

(22) Filed: Mar. 30, 2005

(30) Foreign Application Priority Data
Apr. 29, 2004 (TW) 93111992

(51) Int. Cl. H04N 1/40

(52) U.S. Cl. 715/700

(57) ABSTRACT

A method of input switching in an electronic device. If a first key is pushed, an input mode is switched. Each input mode comprises various inputs. If a second key is pushed, the input within the input mode is switched.

### BACKGROUND

The present invention relates to input switching method and switching among a plurality of input modes.

Portable electronic communication devices, such as mobile phones or personal digital assistants (PDAs) generally provide various input modes. A single key is commonly designated to execute the switching between the input modes. The single key can be a standard key or rotatable. The single key combines the input modes as a one-dimensional menu. When input modes are switched, the one-dimensional menu is selected sequentially until the desired result appears.

For example, in a portable electronic communication device comprising two input modes, such as, Chinese and English, the Chinese mode can include phonetic transcription, sound combination, and character strokes inputs and English mode, capitalization, lowercase, number, and symbol inputs. All the inputs are arranged sequentially and utilize one key for selection. To switch from, for example, the phonetic transcription input in the Chinese mode to the lowercase input in the English mode, the user may be required to select through sound combination and character stroke inputs in Chinese mode, and capitalization input in the English input mode sequentially.

The operation is inconvenient due to the numerous key strokes, especially for active cross-language communication. To send a message comprising both languages, repeated operations must be executed for each message. For example, a message comprising Chinese and English is sent by a portable electronic communication device, according to the previous mentioned method, users have to push the switching key between Chinese and English input modes, and inputs therein repeatedly. However, users generally have their own favorite input mode and inputs and may not change frequently. For example, if the phonetic transcription is a favorite input in Chinese mode for a user, the user generally selects the phonetic transcription to input Chinese and may not change it frequently. Therefore, the previously mentioned method is inefficient. SUMMARY

Embodiments of the invention provide an input switching method for an electronic device. The electronic device comprises a first key and a second key, switching input modes provided by the electronic device when the first key is pushed. Each input mode comprises several inputs. The method switches inputs within an input mode if the second key is pushed.

An input switching method for an electronic device is provided. The electronic device provides input modes and each input mode comprises inputs. When a first key on the electronic is used, input modes are switched. When a second key on the electronic device is used, inputs in one of the input modes are switched. Here, the input modes comprise language input mode and symbol input mode. The first and the second keys can be a star key and a pound key.

### BRIEF DESCRIPTION OF THE DRAWINGS

Embodiments of the present invention can be more fully understood by reading the subsequent detailed description and examples with references made to the accompanying drawings, wherein:

FIG. 1a is a flowchart of an embodiment of the input switching method.

FIG. 1b is a flowchart of practical implementation of the input switching method.

FIG. 2a is a diagram of a machine-readable storage medium for storing a computer program of input switching according to an embodiment of the invention.

FIG. 2b-2c are diagrams of a computer program for input switching according to an embodiment of the invention.

FIG. 3 is a diagram of an electronic device providing input switching function according of an embodiment of the invention.

FIG. 4 is a diagram of an exemplary implementation of an input device.

FIG. 5a-5e are diagrams of the input switching method according to an embodiment of the invention.

### DETAILED DESCRIPTION

The invention provides an input switching method for an electronic device by use of keys thereon. The electronic device, which can be a portable electronic communication device, comprises a first key and a second key.

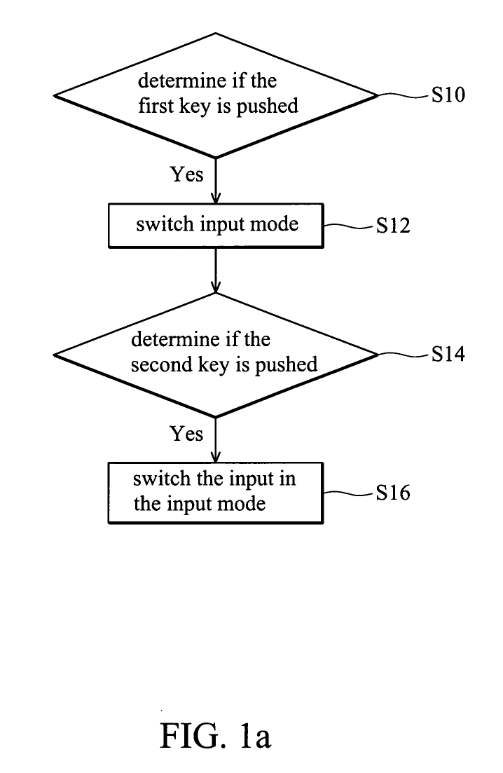

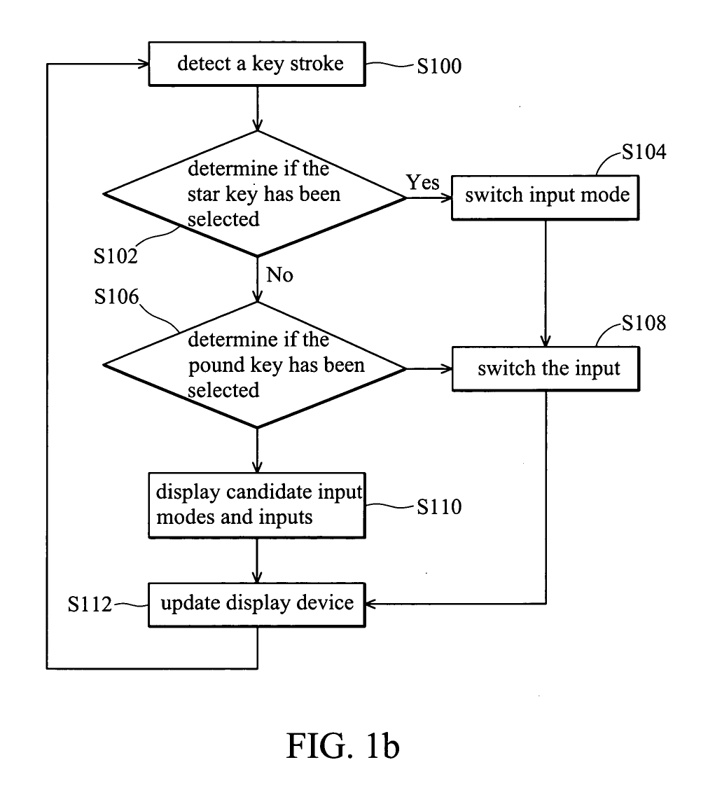

FIG. 1a is a flowchart of this embodiment of the input switching method. The method first determines if the first key is pushed (step S10). If so, input mode is switched (step S12). It is then determined if the second key is pressed (step S14). The input in the input mode is switched if the second key is pressed (step S16).

Input modes may include a language input mode and a symbol input mode. A default input mode and default input are stored in a storage unit, such as a flash memory. The default input mode is displayed before input mode switching and a default input displayed before input switching. Operations of the first key and the second key are identified by display on the electronic device.

FIG. 1b is a flowchart of practical implementation of the input switching method, as an example, a portable electronic communication device comprising at least a star key and a pound key.

The portable electronic communication device first detects a key stroke (step S100). It is then determined if the star key has been selected (step S102). If so, input mode is switched (step S104). If not, it is determined if the pound key has been, selected (step S106). If so, the input is switched (step S108).

Referring to step S104, a default input mode is first displayed before input mode switching. If default input mode is selected, input switching is terminated. Referring to step S108, a default input is displayed before input switching. If the displayed input is selected, input switching is terminated. If the key selected is neither the star key nor the pound key, all candidate input modes and inputs are displayed (step S110). Finally, the display device is updated and awaits user input (step S112).

The input mode and corresponding input are stored when text input is terminated or turned off. The storing can reserve the input mode and corresponding input for next turn on. Thereafter, if a user executes text input, the reserved input mode and corresponding input can be switched by pushing one key. The storing can be accomplished by a flash memory device which does not affect recorded input modes and inputs when a portable electronic communication device is turned on or turned off.

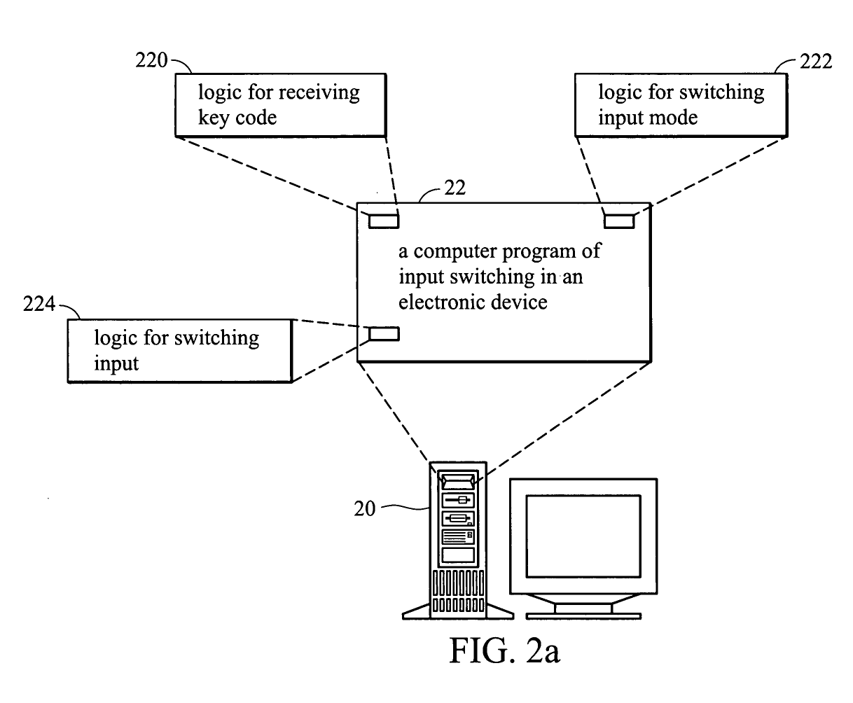

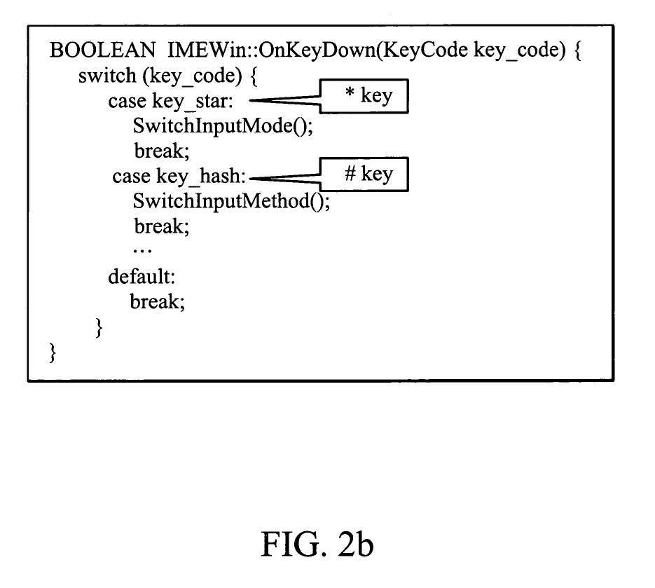

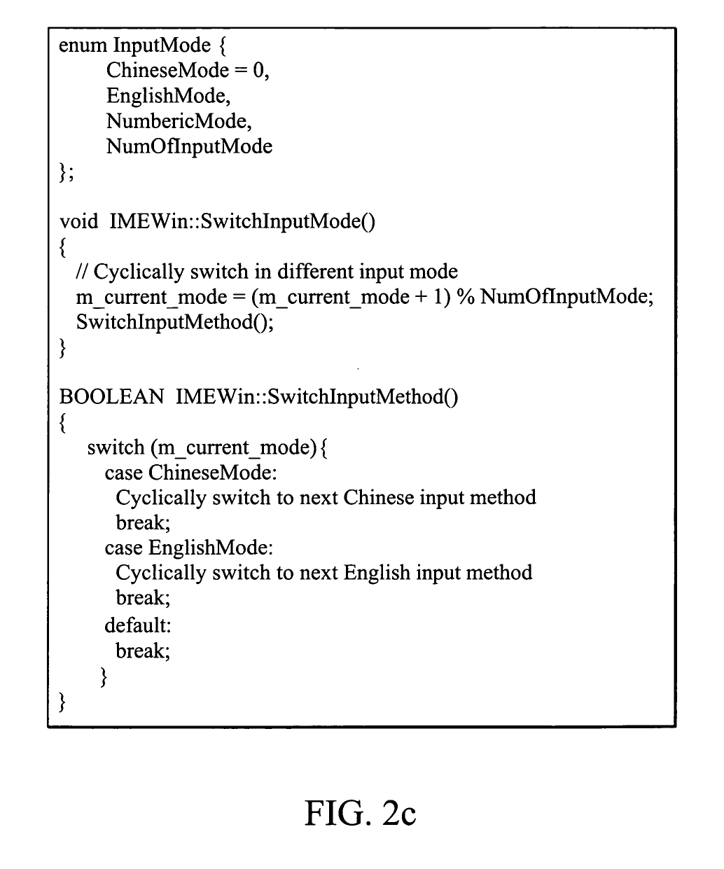

FIG. 2a is a diagram of a machine-readable storage medium for storing a computer program of input switching according to an embodiment of the invention. As shown in FIG. 2a, machine-readable storage medium 20 stores a computer program 22 for input switching in an electronic device. The computer program 22 mainly comprises logic for receiving key code 220, logic for switching input mode 222, and logic for switching input 224.

FIG. 2b-2c are diagrams of a computer program for input switching according to an embodiment of the invention. Logic 220 receives key code from an input device. If the key code corresponds to a star key, logic 222 executes input mode switching. Logic 222 also displays the switched input mode and the inputs thereof. If the key code corresponds to a pound key, logic 224 switches inputs in one input mode. Here, logic 224 also displays inputs for user selection.

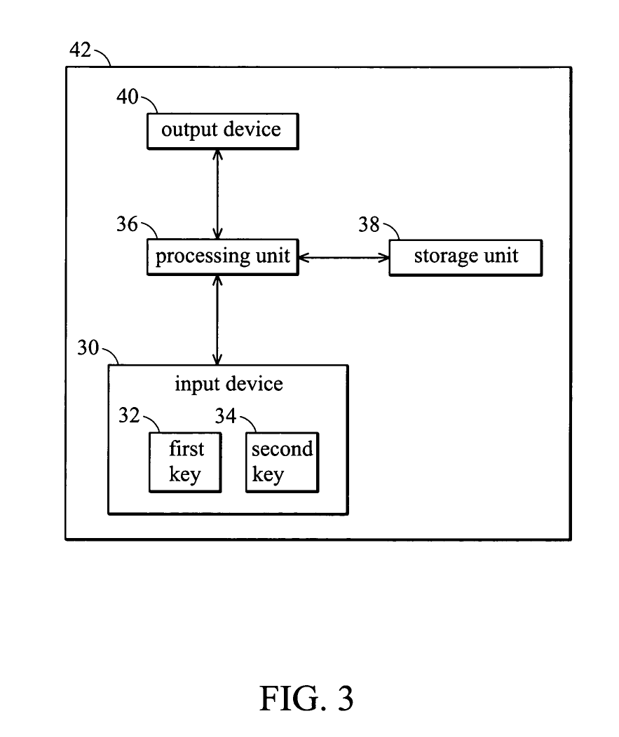

FIG. 3 is a diagram of an electronic device providing input switching function according of an embodiment of the invention. The electronic device 42 comprises an input device 30, a processing unit 36, a storage unit 38, and an output device 40. The input device 30 includes a first key 32 and a second key 34, generating corresponding key code.

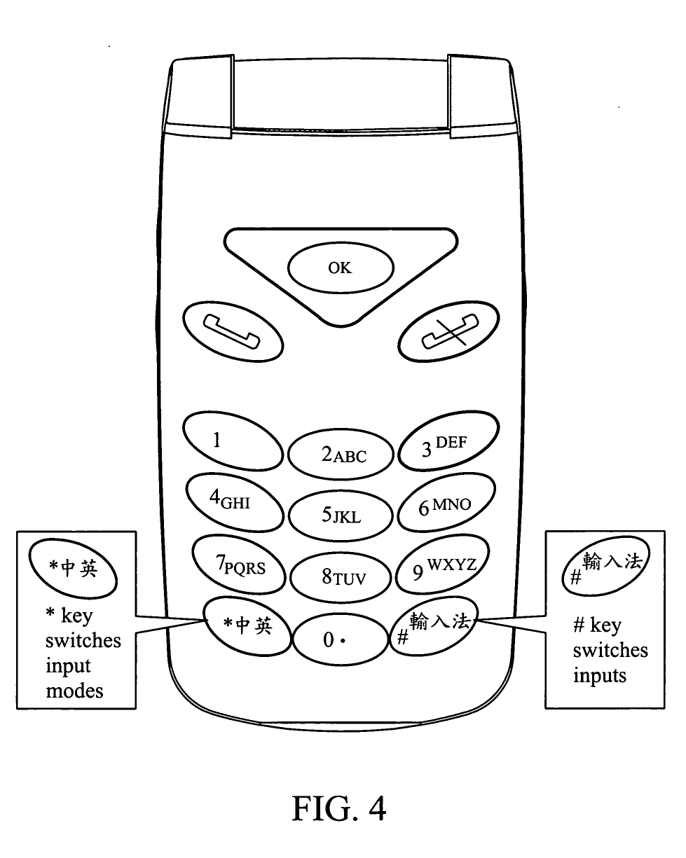

FIG. 4 is a diagram of an exemplary implementation of an input device. The input device 30 in a portable electronic communication device 42 comprises a star key and a pound key. The star key switches input modes, such as, for example, Chinese and English modes. The pound key switches inputs within the Chinese or English modes. The Chinese mode comprises three inputs, phonetic transcription, sound combination, and character strokes. The English mode comprises four inputs, capitalization, lowercase, number, and symbol.

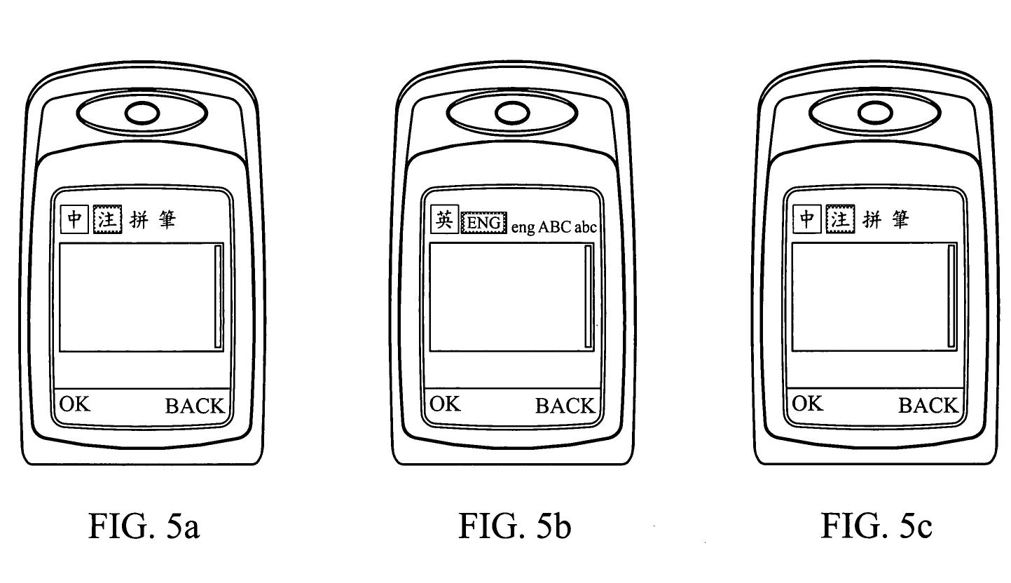

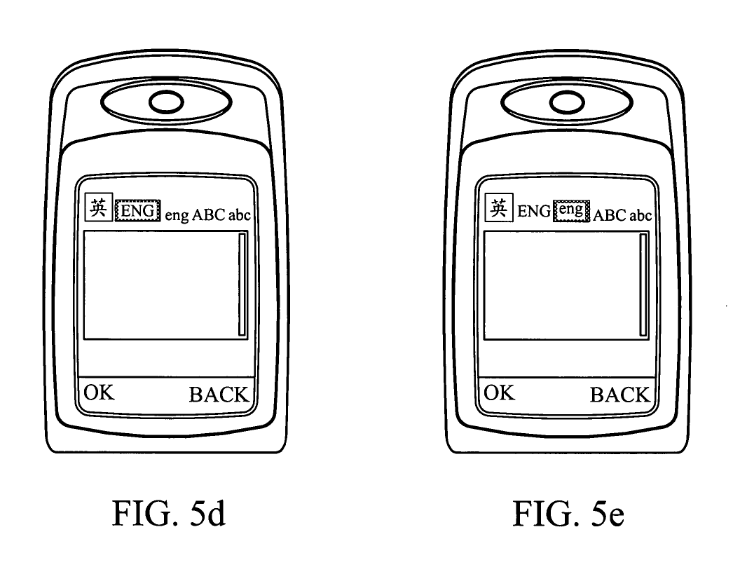

If, in the example, the phonetic transcription input in the Chinese mode is currently active and the capitalization input was previously stored in the English mode, as shown in FIG. 5a, to return to the capitalization input in the English mode, only the star key need be uses, as shown in FIG. 5b.

Referring to FIG. 5c, if the phonetic transcription input in the Chinese mode is currently active and the lowercase input was previously stored in the English mode, to return to the lowercase input in the English mode, first the star key switches to English mode. The processing unit 36 receives the key code from the input device 30. If the received key code corresponds to star key 32, the processing unit 36 switches input modes for the portable electronic communication device 42.

Since the previously stored input in English mode was capitalization, the pound key switches to the lowercase input, as shown in FIG. 5e, after which processing unit 36 receives the key code from the input device 30. If the received key code corresponds to the pound key 34, the processing unit 36 switches inputs to lowercase input. The processing unit 36 also displays the currently used input mode and input.

Afterward, the currently used input mode and input are stored for future operations. The storage unit 38 stores the currently used input mode and input in the storage unit 38, such as flash memory. The stored input mode and input manner can be restored in the next operation.

It will be appreciated from the foregoing description that an embodiment of the invention disclosed herein may provide a dynamic and robust solution to input switching problems.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An input switching method for an electronic device, wherein the electronic device provides a plurality of input modes, each input mode comprising a plurality of inputs, the method comprising the steps of:
switching among the plurality of input modes when a first key on the electronic is used; and
switching among the plurality of inputs in one of the input modes when a second key on the electronic device is used.

2. The method as claimed in claim 1, wherein the input modes comprise language input mode and symbol input mode, and the first and the second keys are a star key and a pound key.

3. The method as claimed in claim 1, wherein the first key enables a first selection of input mode and the second key enables second selection of inputs, wherein the first and second selections are executed by the electronic device.

4. The method as claimed in claim 3, wherein the first and second selections are displayed on a display device.

5. The method as claimed in claim 1, further displaying a default input mode before the input mode is switched.

6. The method as claimed in claim 1, further displaying a default input before the input is switched.

7. The method as claimed in claim 1, wherein the electronic device is a portable electronic communication device.

8. An electronic device providing input switching function, the electronic device comprising a processing unit and a storage unit, the storage unit comprising a program executed by the processing unit, comprising:
switching among a-plurality of input modes when a first key on the electronic device is pushed, each input mode comprising a plurality inputs; and
switching among a plurality of inputs in one of the input modes when a second key on the electronic device is used.

9. The electronic device as claimed in claim 8, wherein the input modes comprise a language input mode and a symbol input mode, and the first and the second keys are a star key and a pound key.

10. The electronic device as claimed in claim 8, wherein the first key enables a first selection of input modes and the second key enables second selection of the inputs, wherein the first and second selections are executed by the electronic device.

11. The electronic device as claimed in claim 10, wherein the first and second selections are displayed on a display device.

12. The electronic device as claimed in claim 8, the program further displaying a default input mode before input mode is switched.

13. The electronic device as claimed in claim 8, the program further displaying a default input before input is switched.

14. The electronic device as claimed in claim 8, wherein the electronic device is a portable electronic communication device.
